(19) United States
(12) Patent Application Publication
(10) Pub. No.: US 2016/0082678 A1
(43) Pub. Date: Mar. 24, 2016

(54) TIRE REPAIR TOOLS AND METHODS

(71) Applicant: Avelino Rivera, Austin, TX (US)

(72) Inventor: Avelino Rivera, Austin, TX (US)

(21) Appl. No.: 14/490,339

(22) Filed: Sep. 18, 2014

(51) Int. Cl. B29C 73/08; B29C 73/30

(52) U.S. Cl. CPC B29C 73/08; B29C 73/30; B29L 2030/00

(57) ABSTRACT

Disclosed are systems and methods for repairing a tire puncture wound. In one embodiment, a tire wound repair kit includes a platform configured to receive application of force by a foot, wherein the platform is coupled to a tire plug insertion tool. The kit can include a foot strap and a leverage strap. In some embodiments, a method of repairing a tire puncture wound involves affixing a tire plug insertion tool to a platform, and applying force by foot to the platform to drive the tire plug insertion tool into the tire puncture wound. In other embodiments, a tire puncture repair tool includes a container adapted to transmit foot force, a lid fastened to the container, and a tire plug insertion tool coupled to the container. In one embodiment, a foot strap is coupled to the container.

### PRIORITY CLAIM

None.

### BACKGROUND

1. Technical Field

The present invention relates generally to tire repair tools and methods. More specifically, embodiments of the invention are directed to tire repair tools that reduce the physical effort required to fix a tire puncture, with tire plugs, without having to dismount the tire from the vehicle or having to remove the tire from the wheel.

2. Description of the Related Art

Despite the fact that tire technology has produced highly durable tires that are largely resistant to puncture wounds, it is nevertheless true that sometimes a tire with substantial service life left will be punctured by, for example, a nail, bolt, or screw. In such a situation, for primarily economic reasons and purported safety reasons, tire merchants will recommend that the tire be trashed. Additionally, it has become common for many tire dealers and tire repair shops to refuse to repair tires in such circumstances, leaving the consumer with no choice but to purchase a new or used replacement tire.

One response to this state of affairs has been to provide consumers and interested tire repair shops with tools that simplify the operation and reduce the effort required to repair a tire wound. It should be noted, however, that tire wound repair technologies have been available for nearly the entire history of the existence of pneumatic tires. What follows is a partial review of such technologies as primarily documented in patents granted or patent applications published by the United States Patent Office.

It has been said that “[c]ar owners could count on making a tire repair on nearly every drive they took in the 1890s because tires weren't sophisticated. In those days, the repairs were made by the car owner, for the most part.” Interestingly, for more than 120 years the basic principle of repairing a pneumatic tire has remained the same. In 1899, the patent office granted patent 636,369 on a “Device for Sealing Punctures in Pneumatic Tires”. The basic method is to introduce a plug into the tire wound (usually a puncture hole made by a nail, screw, or the like). The tool used to insert the plug into the wound has primarily been either a hand-activated tool or a powered tool. One such hand tool is shown in the 636,369 patent. The device of 636,369 patent is activated by hand (“the device is grasped in one hand, and the shaft 22, with rubber bands 27 connected therewith, is forced inwardly into the tire through the puncture or hole 6”).

1,180,911, granted in 1916 and titled “Device for Repairing Punctures,” shows “a compact, simple, cheap device adapted to be conveniently carried in the pocket or tool kit.” The device includes a “container having therewithin all of the necessary implements or devices to repair a puncture.” The device includes the “capability of the container to open to constitute a handle for the tool, the container having rigidly secured thereto an inserting implement for rubber bands adapted to close the puncture [ . . . ] the inserting implement having a shank portion formed to constitute a reamer to enlarge the aperture or puncture and render the same smooth, and having a sharp edge for severing the inserted bands close to the outer surface of the tube or tire.” As claimed, the device includes “hinged sections adapted to be closed to constitute a container or opened back to back to constitute a handle, in combination with an implement adapted to be operated by said handle and to be confined within the container when closed.”

In 1963 the Patent Office granted U.S. Pat. No. 3,083,597 for a “Repair Device”. Because it takes considerable force or effort to insert the plug into the puncture of a tire, this patent teaches the use of “a pneumatically operated ram gun for forcing the plug into the puncture of the tire”. The “handle 1 [of the gun] is provided with an opening 22 adapted to be connected to a source of compressed air or other gas.” It is explained that upon “firing the gun [ . . . ] a compression force [is applied] on the plug”.

In 1970 the Patent Office granted U.S. Pat. No. 3,545,314 for a “Tire Plugger”. The specification states that an object of the disclosed device is “to feed a plug [ . . . ] by a simple manually operated gun-like tool in which the griping force of the user's hand or hands is multiplied and directed in a straight line axially of the tool barrel to thrust the plug [ . . . ] into the tire casing from the exterior of the casing.”

In 1974 the Patent Office granted U.S. Pat. No. 3,785,896 for a “Tire Puncture Repair System”. The specification states: “Many devices have been used heretofore for the purpose of sealing puncture wounds in pneumatic tire casings. For the most part, these devices had substantial drawbacks which accompanied their usage. [Some methods] necessitated the removal of the tire from the rim to which it was mounted. When the punctured tire was a tubeless tire, the removal of the tire from the rim was especially undesirable since it necessitated a breaking of the joint between the tire casing and the rim thereby increasing the possibility of subsequent joint leakage. Furthermore, removal of a tire casing from the rim necessitated a rebalancing of the tire after the casing was again mounted. It will be appreciated that such repair was costly and time consuming.”

The '896 patent further explains that “[T]o repair the wound, a gun was used to force the plug, head first, through the tire casing wound.” The '896 patent shows an “insertion tool 10 [that] includes a pistol grip stock 16 from which a forwardly projecting shank 18 extends. An insertion needle 20 is releasably mounted to the free end of the shank 18.” In use, “the needle 20 is forced though the puncture wound of the tire casing[, and] the needle is thereafter pulled from the puncture wound leaving the repair plug seated on the wound aperture.”

In 1974 the Patent Office granted U.S. Pat. No. 3,837,243, titled “Rubber-Material Inserter”. This reference teaches that [i]t is known to repair tubeless tires, and the like, while they are still mounted on an associated wheel because of the difficulty in removing such tires from a wheel. The most commonly used tool for inserting a plug into a tubeless tire puncture has a needle-like shape. FIGS. 1 and 2 of the drawings show a tool in the form of a plug inserting apparatus in the process of inserting a headed plug or insert element 11 into a, for example, tubeless tire 12. Apparatus 10 features a cylindrical housing 14, which may be, for example, knurled, and the like, to improve a hand grip on it, and a knob-like handle 16 which may be provided with various kinds of conventional finger grips.” Thus, the '243 patent illustrates another hand tool for repairing tire wounds.

In 1976 the Patent Office granted U.S. Pat. No. 3,945,274, titled “Tire Repair Tool”. The '274 patent states: “Heretofore, tire repair tools have included a tube which is adapted to be inserted into a tire to provide a passageway for the introduction of tire repair material. Such tubes have been rigidly connected to a handle by means of which the tube could be inserted through the wall of the tire. With the advent, however, of steel belted tires, the tubes, being relatively thin in wall thickness. have fractured easily due to the increase in pressure required to force the tube through the tire wall. When such fracture occurred, it was necessary to discard the entire assembly of tube and handle thus requiring each tire repair station to maintain a supply of the handle and tube assemblies for replacement purposes.”

The '274 patent further explains that “[t]he tire repair tool [ . . . ] includes a hand actuated tubular member which is adapted to be inserted through the wall of a vehicle tire at the point of injury to the tire. The tube [ . . . ] provides a passageway through which a tire repair strip may be inserted by means of a forked needle [ . . . ]. The needle is then withdrawn [ . . . ], thereby leaving the tire repair material embedded within the tire.” Hence, the '274 patent teaches the use of hand tool, but it also points out that the new steel belted tires had resulted in requiring a greater force to be used to insert the plug into the tire.

In 1980 the Patent Office granted U.S. Pat. No. 4,205,565, titled “Tire Repair Apparatus and Method”. The '565 patent explains that its teachings are related “to devices for repairing injuries in tubeless-tires and, in particular, to the repair of tubeless tires having belts under the tread thereof constructed of stiff materials such as steel.” After discussing various known tools and methods known for repairing tire wounds, the '565 patent asserts that “[p]roblems have arisen, however, with prior art devices of this general type which are used to repair tubeless tires having stiff belts such as steel underneath the tread.” The '567 patent explains that “[a]lthough this may have been a simple matter when repairing early tubeless tires, the mesh of present day steel belts is very stiff and resistant to attempts to enlarge injuries through the belt.” To address the perceived problems, this references discloses “a needle plug injection tool 50 which includes a handle 51[, which] carries a needle 18 defining an eyelet 19. A tire repair plug 16 is fitted into the eyelet 19 of the needle 18.” Thus, while recognizing that significant effort is required to fix steel belted tires and that the prior devices and methods are inadequate for this task, the '567 patent nevertheless provides a hand operated tool as a solution.

In 1990 the Patent Office issued U.S. Pat. No. 4,930,377, titled “Tire Repair Kit”. This reference teaches “a device and kit especially adapted for inserting plugging material in the form of a twisted rubber coated fibrous strand into such punctures and for trimming and excess thereof.” The '377 patent asserts that it aims “to provide a tire repair tool which will improve the efficiency of the repair of punctures in tubeless automobile tires”, in part by providing “a kit which contains all the tools necessary for undertaking said repair.” The '377 patent discloses “a tire repair device and kit [ . . . ] which is comprised of a handle member, one or more tools and means for interchangeable joining one of the tools to the handle. [T]he handle member is comprised of two handle portions which when joined together form an internal, enclosed space therebetween in which the tool or tools, the plug material and the like may be maintained and stored.” By way of example, “the tools contained in the kit include a knife, an awl, a screw driver and a plug material inserting needle.” Hence, although the '377 patent teaches that a kit might be useful in tire repair, the '377 patent still provides a solution that involves a handheld tool.

In 1991 the Patent Office granted U.S. Pat. No. 5,033,140, titled “Multipurpose Combination Tool”. The '140 patent discloses a “tire-repairing kit incorporated into [a] combination tool.” The kit “consists of the needle file (7), the dual pairs of pinchers (8), a sample piece of rubber (30), and a piece of steel rod (9). The dual pairs of pinchers (8), all four pieces, are designed to insert a piece of rubber (30) into the hole of the tire.” Thus, the '140 patent illustrates yet another kit that incorporates a hand operated tool for tire repair.

In 1995 the Patent Office issued U.S. Pat. No. 5,461,945, titled “Tire Puncture Repair Device”. This references discloses “a portable and manually operated tire puncture repair device.” The '945 patent explains that “[c]onventional tire puncture techniques generally involve a resilient sealing member which is grasped on the end of a sharp implement which is subsequently impaled through a puncture aperture on a tire using considerable strength [ . . . ]. Though functional, the more conventional tire puncture techniques are generally cumbersome requiring a relatively large degree of physical exertion. Further, the large insertion forces often require that [the] wheel [be] removed from the vehicle.” The '945 patent purports to provide a “more efficient tool which requires relatively low insertion forces and which can be operated by unskilled personnel without undue manipulations”, or a device that “requires much reduced user exertion and which facilitates tire repair by non professionals”. To address the perceived shortcoming in the known methods and tools to overcome the “large degree of physical exertion,” the '945 patent discloses a “handle with an attached shank member.” The tool disclosed “comprises a shank member 20 attached on a rear end to a handle 10 adapted for torque application, a generally conical penetrator 30 attachable to the fore end of the shank member, and a combined bolt/cover assembly 40.” Thus, it should be noted that, nearly 100 years from the issuance of the 1899 patent '369 discussed above, the known tools and methods for repairing tire wounds primarily have recognized only the use of handheld tools. This has been so despite the fact that new kinds of tires (i.e., steel belted tires) require much greater degree of physical exertion.

In 2001 the Patent Office granted U.S. Pat. No. 6,170,361, titled “All-In-One Tire Repair Tool”. This references discloses “tools for inserting repair plugs into tubeless tires without the need to remove the tire from the rim on which the tire is mounted.” The '361 patent explains that in tubeless tires the “side of the tire has a bead which butts against a corresponding portion of the wheel rim forming an air-tight seal. No tube is required in these types of tires.” Additionally, “[s]pecial tools are generally required to remove the flat tire from the rim to enable a hole in the tire to be repaired. Therefore, it is desirable to have a tool which allows a hole in a tubeless tire to be repaired without removing the tire from the wheel rim.”

The '361 patent further states that “[d]evices for repairing holes in tubeless tires without removing them from the rim are well known. A primary type of device for repairing holes in tubeless tires without removing them from the rim on which they are mounted employ a substantially cylindrical rubber ‘plug’ and a tool for inserting the plug into a hole.” The '361 patent them discusses certain issued patents.

The '361 patent shows a “an all-in-one tool which contains all of the various parts required to effect a repair in a tubeless tire.” The tool incorporates “a handle including a compartment defined therein for storing extra plugs, a shaft drivingly engaging the handle with a plug hook means incorporated therein and a reamer at an end of the shaft opposite from the point where the shaft attaches to the ratchet means.” Additionally, “[t]he handle 12 is hollow and defines a compartment 14 therein used to hold spare plugs 46.” The '361 patent states that “[i]n operation, a user grasps the handle 12 in one hand and guides the tip 48 into a hole in a tire to be repaired with his other hand. The user then sets the direction switch 44 so as to cause the reamer blades 32a-32d to cut the hole to a sufficiently large dimension to allow the shaft and plug to be inserted. [ . . . ]. Once a sufficiently large hole has been reamed, the user places a plug 46 against the cup portion 38. [ . . . ]. The user uses his free hand to hold the plug 46 against the cup portion 38 [ . . . ]. Then, the user presses the shaft through the hole until the plug contacts a surface of the tire. The user pushes the shaft 25 and the cup portion 38 with the plug 46 engaged therein through the hole until the shorter portion of the plug is inside the tire. The user then cuts off the longer portion of the plug 46 even with the surface of the tire.”

Thus, the '361 patent recognizes that in certain circumstances it is either not possible or not desirable to remove the tire from the wheel. The solution that the '361 patent offers is limited to a hand operated tool.

In 2001 the Patent Office issued U.S. Pat. No. 6,202,510, titled “Tire Plug Insertion Tool”. This reference shows a “tire plug insertion tool [with] an elongated handle having a flanged wheel-engaging shaft adjustably and pivotally mounted in a slot in one end of the handle. A carriage sleeve is slidably and adjustably mounted on the handle and a plug insertion shaft, having a bifurcated bottom end, extends downwardly from pivotal attachment to the carriage sleeve. After the wheel having the punctured tire is optionally removed from the automobile or vehicle, the flanged bottom end of the vertical wheel-engaging shaft is caused to removably engage the cupped wheel rim or hub, and the handle is extended horizontally over the tire tread. The plug insertion shaft is then located above the puncture opening in the tire tread, by manually sliding the carriage sleeve and suspended plug insertion shaft along the handle and securing the carriage sleeve in place. A resilient, band-shaped repair plug is inserted between the bifurcations of the plug insertion shaft, which is next extended into the puncture opening in the tire casing by pivoting the handle downwardly on the wheel engaging shaft. Upon lifting the plug insertion shaft from the puncture opening by pivoting the handle upwardly, the repair plug becomes detached from the plug insertion shaft, sealing the opening.” Hence, the '510 patent teaches the use of a hand-actuated, mechanical lever to fix a tire wound.

In 2008 the Patent Office published patent application 2008/0105090 A1, titled “High-Speed Tire Repair Tool”. This references discusses that when a tire receives a puncture wound, “two tools are generally needed to plug the hole. One of the two tools is an abrasive tool 80, and the other one is an inserting tool 90. As shown in FIG. 1, the abrasive tool 80 includes a first handle 81 and a first inserting stem 82 having a toothed outer surface 83; and as shown in FIG. 2, the inserting tool 90 includes a second handle 91 and a second inserting stem 92 having a pointed end 93 formed of a hole 94. To repair the tire, first rotate while drive the first inserting stem 82 of the abrasive tool 80 into the hole on the high-speed tire; use the toothed surface 83 of the first inserting stem 82 to trim an inner wall surface of the hole; and then pull out the first inserting stem 82. Thereafter, insert a rubber strip (not shown) in the hole 94 on the insertion tool 90; apply glue over the rubber strip; rapidly insert the insertion tool 90 along with the rubber strip into the hole; and immediately jerk back the insertion tool 90 with one swift move. When the insertion tool 90 is pulled out of the hole, the rubber strip is left in and adheres to the hole. The rubber strip and the glue stuff and accordingly, plug the hole to ensure that air does not leak from the tire when the tire is inflated.” This description basically summarizes the tools and methods that have been used for more than 100 years to fix tire wounds.

The '090 application states that “it would be laborious to repair the tire with the two repair tools 80, 90 because the car tire has a relatively large thickness.” The solution offered by this reference is to provide a specially adapted power drill and associated plug insertion tool. Hence, this reference attempts to reduce the effort required to fix a tire wound by providing a powered, rather than hand-operated, tool.

In 2008 the Patent Office published patent application 2008/0265453 A1. “Tire Repair Tools and Method”. The '453 application teaches that “[t]here are numerous tire repair devices that use rubber coated plugs to seal a hole in a tubeless tire. [ . . . ]. An implement is known for forming a repair plug and inserting it into a tire casing to seal a puncture wound. The implement includes an insertion needle having a hook adjacent its free end and a gaff retractable away from the needle. However, both these tools require great physical strength to insert a sealing plug into the puncture in a tire. Accordingly, there is a clearly felt need in the art for tire repair tools, which do not require great physical strength to insert a sealing plug into a tire.”

The '453 application discloses “tire repair tools and method, which require less physical strength to fix a puncture than that of the prior art. The tire repair tools and method preferably includes a rasp tool, an insertion tool and a power tool. The rasp tool preferably includes a modified drill bit and a quick release end.” Additionally, the “insertion tool preferably includes a plug retention end, a shank and the quick release end.” In operation, the “quick release end is inserted into a quick chuck. The quick chuck is retained in the chuck of the power tool.” The method proceeds by “inserting the rasp tool into a tire hole and stroking the rasp tool in the tire hole several times to produce a clean hole, while rotating in a drill. Next, the sealing plug is inserted into the plug slot and coated with glue. The insertion tool is then inserted into the tire hole and the drill actuated intermittently, until the insertion tool is fully inserted into the hole.” Thus, it is apparent that the '453 application teaches the use of a powered tool, namely a drill, in an attempt to overcome the need for “great physical strength to insert a sealing plug into the puncture of a tire.” To be sure, the '453 application also illustrates a tool wherein the “quick release ends of the rasp and insertion tools are replaced with a socket end. The socket end is sized to receive a ratchet projection.” In this latter tool, manual mechanical leverage is provided by the use of a ratchet that acts as a lever for application of hand and arm force.

In 2008 the Patent Office published patent application US 2008/0053277 A1, which issued in 2010 as U.S. Pat. No. 7,677,136, titled “Pneumatic Tire Puncture Repair Device”. The '136 patent discloses a “tire repairing assembly for inserting a resilient tire puncture plug into a punctured pneumatic tire. The assembly being adapted to be rolled over by the tire while still mounted to the wheel and the wheel mounted to the automobile. The tire repairing assembly having an arcuate base member and an insertion pin mounted to the base member.”

The '136 patent recognizes that “tubeless tires are difficult to remove from the wheel rim, even when they are flat. Special tools are generally required to remove the flat tire from the rim to enable a hole in the tire to be repaired.” The '316 patent explains that “[d]evices for repairing holes in tubeless tires without removing them from the rim are well known. A primary type of device for repairing holes in tubeless tires without removing the punctured tire from the rim on which they are mounted employ a substantially cylindrical rubber “plug” and a tool for inserting the plug into a hole. Several prior methods for repairing punctures in tubeless tires are known to have several disadvantages, including removal of the wheel assembly from the automobile. Additionally, tires of late include several layers of metallic and/or synthetic reinforcing cords. Thus, repairing tubeless tires where such repair devices attempted to place rubber elements into a puncture hole have not been practical, typically making insertions difficult and positioning uncertain. This procedure is more difficult to perform when the vehicle ride height is low, the puncture is on the inner edge of the tire, the tire is very large with thick treads, or the puncture hole is very narrow.”

The '136 patent further asserts that “[p]rior attempts to produce a tire puncture device [ . . . ] include some means by which a person must forcibly insert a pointed device into the puncture. For example, U.S. Pat. Nos. 2,990,736; 3,029,671; and 4,009,624 disclose hand tools having a probe member or shaft that expands the hole, and a plug carrier or insertion channel. The tools include a pressure head or knob suitably configured to facilitate pressing the hand against it for forcing the shaft and plug into the hole.” Additionally, “[a]nother problem with the prior tire repair devices is that some require specific types or designs of resilient plugs to be used, limiting the utility of the device to the availability of the specific resilient plugs.”

To address the perceived flaws in the prior methods and tools for repairing a tire puncture, the '136 patent provides a “tool that allows the user to insert a plugging means of suitable size, configuration and resiliency into a tire having a hole from a penetrating object wherein the wheel is not removed from the automobile and the weight of the automobile is utilized to facilitate inserting the plugging means while the user's hands are in a position of safety during the plug insertion step of the process.” Hence, in recognition to the substantial physical effort and strength required by known tools and methods, the '136 patent offers a solution that employs the weight of the car, rather than some device that amplifies application of human force either mechanically or by way of powered tools.

In 2013 the Patent Office published patent application US 2013/0031759 A1, titled “Device, Kit and Method for Tire Repair”. The '759 application recognizes “the extreme difficulty involved with the attempted usage of the do-it-yourself puncture tire repair kits currently on the market. The currently sold tire repair kits are physically challenging to the user since the user must have strong hand and upper body strength in order to use the current tire repair kits. Great physical strength is further needed in order to jack/lift the car and tire/wheel off the ground surface, in addition to undoing and remove the lug nuts, to lift and remove the tire(s) off of the vehicle especially if the hole is in a rear tire (an area typically tight and very difficult to maneuver in).” Moreover, “attempting to force a much larger diameter consisting of a very sticky tire plug into a very small diametric punctured hole in a tire will require an enormous amount of hand and upper-body strength to perform this task.”

To address the perceived shortcomings of the known tools and methods, the '759 patent discloses “a hand operated, do-it-yourself puncture tire repair kit that [ . . . ] eliminate[es] the need for physical strength (a known common denominator associated with conventional automobile tire repairs), pressure, or force when operational.” Thus, the '759 patent application points out that the known methods and tools fail to aid an ordinary customer in fixing a tire wound without requiring great physical effort. The '759 patent nevertheless provides a solution that depends on “a hand operated” tool.

In 2013 the Patent Office published patent application US 2013/0177369 A1, titled “Tire Puncture Repair Tool”. This reference discloses a tool that “include[s] a handle, a puncture repair screw, and an integral neck between the handle and the puncture repair screw.” Hence, the '369 application illustrates yet another hand operated tool for repairing tire wounds.

In 2013 the Patent Office published patent application US 2013/0327185 A1, titled “Tire Repair Kit”. This references teaches a kit that “prevents or limits injuries, during the use of the kit, while allowing for a greater ease of use.” The '185 application discloses that the kit “allows for easier repair of automobile, motorcycle and bicycle tires with minimum force.” The “kit comprises a hollow body or casing with interior cavities. These cavities can hold at least one metal tube preloaded with repair plugs. The interior cavities may further hold at least one clearing tool [ . . . ] the device may hold an air stopper temporary plug tool [ . . . ] the clearing tool(s) may be a small drill like device with unique cutting flutes [ . . . ] a temporary plug may be included in the kit that can be used to temporarily stop loss of air pressure immediately after the tire damaging puncture element such as a nail or screw has been removed.” By inspection of the figures of the '185 application, for example FIG. 5, it can be seen that the solution of this reference involves a hand operated tool that uses a cap configured to use torque to drive a plug into the puncture wound of a tire. Thus, this reference also recognizes the need for reducing the effort required in fixing a tire wound, but its teachings are directed to hand operated tools.

Having reviewed more than 120 years of technology related to fixing a tire puncture wound, it can be pointed out that the vast majority of tools and methods known involve the use of a hand operated tool. After steel belted tires became available, the physical effort and/or strength required to repair the tire puncture wound increased greatly. The solutions provided to answer this new challenge sometimes involved power tools, either electrical tools or pneumatic tools. In one example, a device was configured to use the weight of the car to provide the force required to insert a plug into the tire puncture wound.

For the sake of completeness, certain current practices (as recommended by tire manufacturers) in tire puncture wound repair are now described. The following is paraphrased from an article by Tom Duke, published on Feb. 2, 2012 and titled “Back to Basics: Basic Tire Repair”. Repairs should be limited to puncture injuries of not more than ¼-inch (6 mm). Where the injury damage extends into the shoulder/belt edge area or where the injury extends at an angle into the shoulder area, the tire must be discarded. It is important to note that “[i]mproperly repaired tires can fail while in service, including tread-belt separations and/or detachments. These occurrences may cause an accident resulting in serious personal injury or death.”

It is recommended to not “perform a tire repair without removing the tire from the rim/wheel assembly and completing an internal inspection.” It is warned that on-the-wheel tire repair products “are not considered full, permanent repairs and should be restricted to temporary use only.” Additionally, “[w]hen repairing a tire, adequate eye protection (goggles or face shields) should always be worn to prevent serious eye injuries. Ear protection should also be worn.”

An online reference found on Jul. 7, 2014 at http://www.ntb.com/tires/Tire-Plug-Repairs-Education.j, titled “The Truth About Tire Plug Repairs”, describes a tire repair method recommended by the Rubber Manufacturer's Association (RMA). First, remove the tire from the wheel. Second, inspect the tire inside and outside. The tire may be repaired when the puncture is ¼ -inch or smaller and is located on the tread. Third, repair the tread with a plug, and repair the lining with a patch. This reference warns that “a plug by itself, or a patch by itself, is not acceptable.” However, a “safer tire repair, done to the RMA standards, can [provide] thousands of miles more use from [a] tire.”

Another online reference, http://www.allpar.com/dealers/repairs/tires.html, found on Jul. 7, 2014, reveals the current state of the technology. It states that a “tire plug is an object that is sticky and expandable and gets stuffed in a hole in the tire from the outside and is wedged in until the air stops leaking out. The plug will stay intact for long enough for you to re-inflate the tire and get safely off the road at a slow speed.” It further states that it “is considered a temporary repair on all street vehicles. ‘On the Wheel’ repairs are classified as emergency only. The tire must not be run more than 100 miles at speeds no greater than 50 m.p.h. until the tire is dismounted, inspected, and permanently repaired or replaced.”

It is clear from the survey above of the know-how related to fixing tire puncture wounds that the insertion of a tire plug into a tire wound is a well accepted method of fixing a tire puncture wound and putting the repaired tire back into service, at least temporarily. Although various methods and tools have been disclosed and employed to fix tire puncture wounds, there still remains in the industry a need for tools and methods that improve the efficiency of, and reduce the physical effort required in, fixing a tire puncture wound with a tire plug. Various embodiments of the inventive tools and methods disclosed next enable repair of tire puncture wounds, by insertion of a tire plug into the wound, with reduced physical effort and improved efficiency over previously known tools and methods.

### SUMMARY OF ILLUSTRATIVE EMBODIMENTS

The invention's illustrative embodiments summarized in this section are exemplary and should not be construed as limiting. The full scope of the invention is to be determined by reference to the claims in view only of the section below titled “Detailed Description of Illustrative Embodiments.”

In one embodiment, a tire puncture wound repair kit includes a container portion adapted to allow application of force to a surface of said container by a human foot. A lid is fastened to the container, wherein the lid includes an orifice configured to allow the passage of the shank of a tire repair implement. A tool retention member is affixed to the container and configured to receive part of the shank. The container portion can be configured to house at least one tire repair implement. The lid can be releasably fastened to the container by a hinge and/or a latch. In some embodiments, a foot strap is coupled to the container. Another aspect of the kit can include a leverage strap configured to facilitate the application of foot force to the container, wherein the leverage strap comprises two distal ends that can be grasped with the hands.

Another feature of the inventions disclosed herein concerns a method of repairing a tire puncture wound. The method includes the steps of affixing a tire plug insertion tool to a container, and applying force via a human foot to the container to drive the tire plug insertion tool into the tire puncture wound. In one embodiment, a container with a tool retention member coupled to the container is provided. In yet another aspect of the inventive method, a surface on the container is provided suitably adapted to receive application of force by a human foot. In some embodiments, a foot strap is coupled to the container such that the foot strap is adapted to receive and retain a human foot. In one embodiment, a leverage strap is provided. The leverage strap is configured to be wrapped around a tire. The inventive method includes pulling the free ends of the leverage strap simultaneously with applying force via a human foot.

In one embodiment, the invention is directed to a tire puncture wound repair tool. The tool includes a platform configured to receive application of force by a human foot, and a tire repair implement coupled to the platform. The platform and the tire repair implement are configured such that application of force by a human foot to the platform drives the tire repair implement into the tire puncture wound. The platform can include a container portion. In some embodiments, the platform has a lid that releasably attaches to the container portion. In yet other embodiments, the container portion has a retaining member for receiving and securing the tire repair implement. In one embodiment, the tool includes a leverage strap configured to be wrapped around a tire and to be pulled by its free ends as a human foot applies force to the platform. In another embodiment, the tool includes a foot strap coupled to the platform.

### BRIEF DESCRIPTION OF THE DRAWINGS

The invention itself will best be understood by reference to the following detailed description of an illustrative embodiment when read in conjunction with the accompanying drawings, wherein:

FIG. 1 is a perspective view of a prior art method of inserting a tire plug into a tire of a vehicle.

FIG. 2 is a perspective view of a tool for and a method of inserting a tire plug into a tire of a vehicle according to an inventive embodiment disclosed in this patent specification.

FIG. 3 is a perspective view of a tire plug insertion tool in accordance with an inventive embodiment disclosed in this patent specification.

FIG. 4 is a perspective view of a tire puncture wound repair tool in accordance with one embodiment of the invention.

FIG. 5 is a perspective view of the tire puncture wound repair tool of FIG. 4 from a different view angle.

FIG. 6 is a perspective view of the tire puncture wound repair tool of FIG. 4 shown in a closed configuration.

FIG. 7 is a cross-sectional view of the tire puncture wound repair tool of FIG. 4.

FIG. 8 is a perspective view of yet another embodiment of the inventive tools and methods for repairing a tire wound disclosed in this patent specification.

### DETAILED DESCRIPTION OF ILLUSTRATIVE EMBODIMENTS

In the following detailed description of exemplary embodiments of the invention, specific exemplary embodiments in which the invention may be practiced are described in sufficient detail to enable those skilled in the relevant technology to practice the invention, and it is to be understood that other embodiments may be used and that other changes may be made without departing from the spirit or scope of the present invention. The following detailed description is, therefore, not to be taken in a limiting sense, and the scope of the present invention is defined fully by the appended claims.

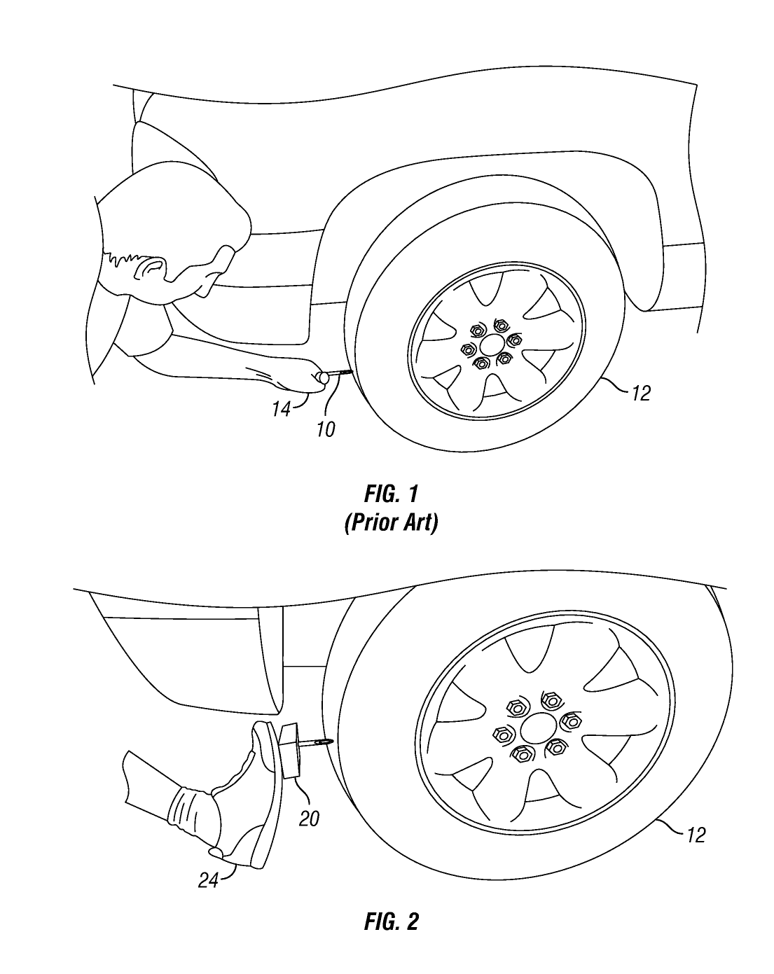

As detailed in the “Description of the Related Art” description above, heretofore the known methods and tools for repairing tire puncture wounds have involved either hand operated tools or powered tools. One exception to this is the use of a device configured to use the weight of the vehicle to drive a tire plug into the puncture wound. FIG. 1 illustrates the known and typical method of using a handheld tire plug insertion tool 10 to insert a tire plug (not shown) into a tire 12 of a vehicle. As shown in FIG. 1, an operator uses a human hand 14 to drive the tire plug insertion tool 10 into the tire 12. As has been amply demonstrated above in the section titled “Background”, this method has been ubiquitous and practically unchanged for more than one-hundred years. The discussion in the Background section also makes it clear that this method and tool have many drawbacks. These drawbacks make it difficult to use the tire plug insertion tool 10 and limit who can repair wounded tires.

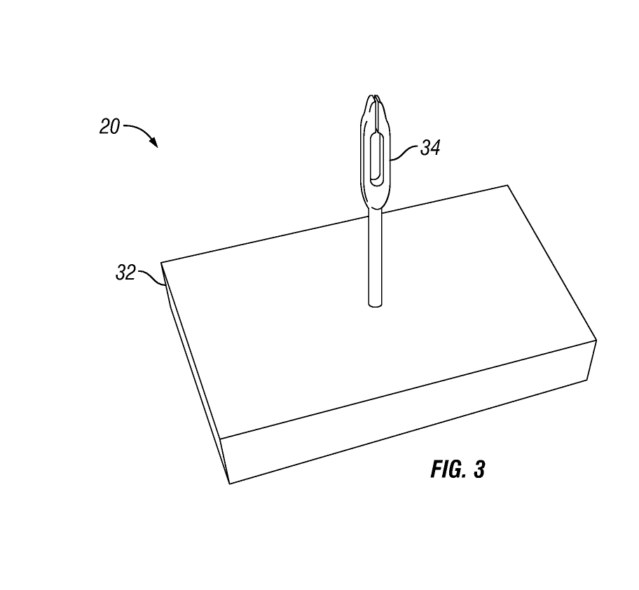

In contrast to the known methods and tools, the inventive embodiments illustrated below provide tools configured to be operated by application of force delivered by a human foot. FIG. 2 shows a method of using a tire plug insertion tool 20 that has been configured to drive a tire plug (not shown) into a vehicle tire 12 through application of force by a human foot 24. The force amplification enabled by such methods and tools greatly reduces the amount of effort and/or physical strength required to introduce a tire plug into a tire puncture wound. As shown in FIG. 3, in one embodiment a tire plug insertion tool 20 includes a platform 32 that is suitably coupled to a tire repair implement 34. The platform 32 is preferably made of a material suitable to support a large force applied to the platform 32. For example, the platform 32 can be made of a metal such as steel or aluminum. In other cases, the platform 32 can be made of hardwood, polymers, composites, or other appropriate synthetic materials. Preferably, the platform 32 is large enough (that is, it provides sufficient effective surface area) to accommodate the adult human foot of average size. Of course, larger sizes of platform 32 can be provided to facilitate use of the platform 32 by those with foot sizes greater than average.

The tire repair implement 34 can be any of different tire repair tools that are customarily used to repair tire wounds. For example, in one embodiment, the tire repair implement 34 can be a tire plug insertion tool such as the one actually shown in FIG. 3. The tire repair implement 34 can be, in other embodiments, an awl, a knife, a screw driver, a rimmer, and the like. The tire repair implement 34 is securely coupled to the platform 32 by, for example, welding the tire repair implement 34 to the platform 32. In other embodiments, the tire repair implement 34 can be secured to the platform 32 by, for example, providing a means to screw the tire repair implement 34 into the platform 32. In yet another embodiment, the tire repair implement 34 is secured to the platform 32 by a friction fit of a shank of the tire repair implement 34 into a hole of the platform 32.

Referencing FIGS. 2 and 3 now, to repair a tire wound (not shown) in a vehicle tire 12, an operator places the tire repair implement 34 against the tire wound. Then the operator uses a foot 24 to apply force to the platform 32, and thereby drive the tire repair implement 34 into the wound of the vehicle tire 12. In practice, the operator may use as the tire repair implement 34 any of a number of tools, such as an awl or a rimmer, which are often used to prepare the tire wound for receipt of a tire plug. As a step in repairing the tire wound, the operator inserts a tire plug into the tire wound by driving a tire plug insertion tool, being tire repair implement 34, into the tire wound through application of force by a foot to the platform 32.

As will be discussed further below, the tire insertion tool 20 of FIG. 2 can be embodied in various forms that provide convenience in, and/or reduce the effort needed in, repairing a tire wound.

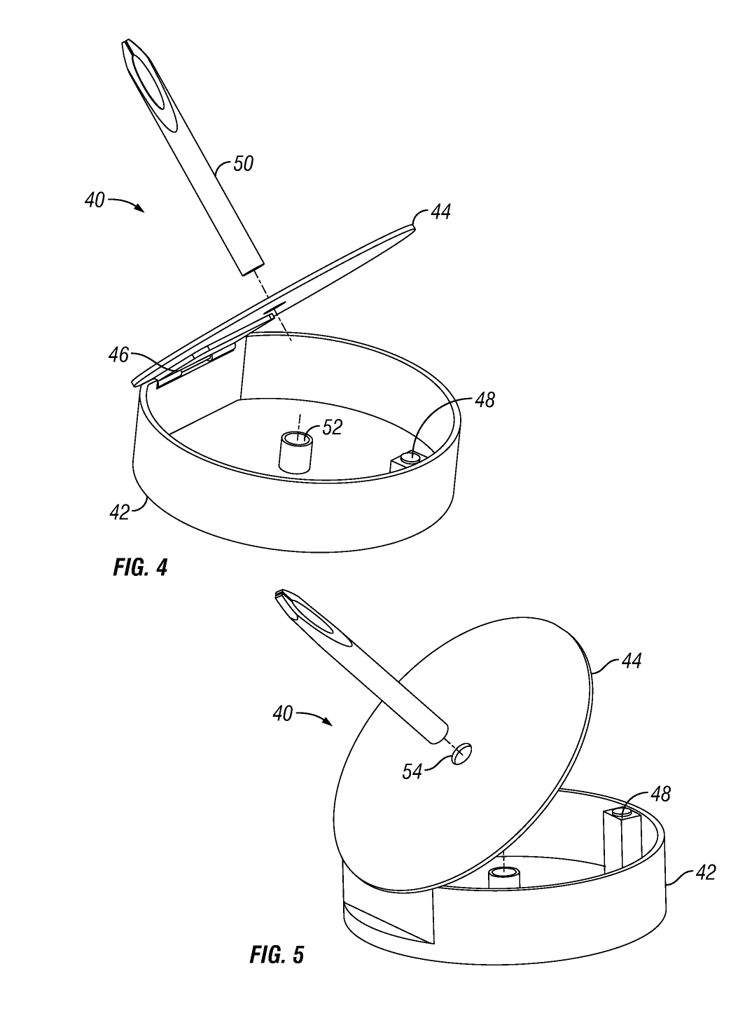

Referencing FIG. 4 and FIG. 5, two perspective views of an inventive embodiment of a tire puncture wound repair kit 40 are shown. In the illustrated embodiment, the kit 40 includes a container 42 that is attached to a lid 44 by means of a hinge 46. In one embodiment, the container 42 is provided with a latch 48 to secure the lid 44 in a closed position. Kit 40 is configured to receive various implements, such as a tire plug insertion tool 50. The lid 44 can include an orifice 54 sized suitably to receive the insertion tool 50. The container 42 is preferably provided with a tool retention member 52 to support and hold securely in place the tire plug insertion tool 50.

The container 42 is preferably made of a material suitable to withstand significant force, such as metal or high strength plastic or composites. In one embodiment, the container 42 is made of aluminum or steel, for example. Although the illustrative embodiment of FIGS. 4-7 shows a generally circular shape for the container 42, persons of ordinary skill in the technology will recognize that the container 42 may take on any number of shapes—so long as the chosen shape allows efficient application of force to the container 42 by an average adult-sized human foot. The latch 48 can be a mechanical latch or a magnetic latch, for example.

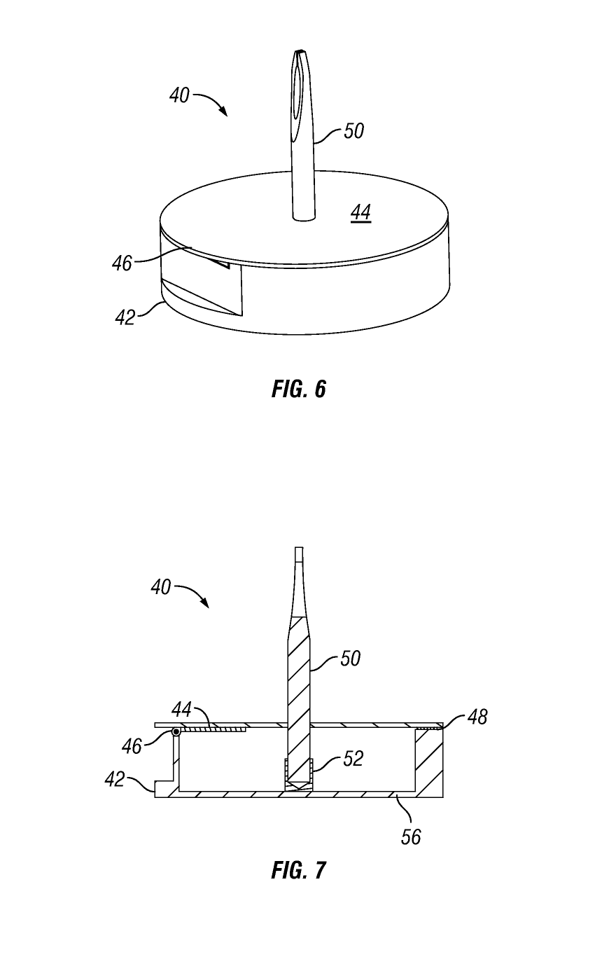

Referencing FIG. 6 now, another perspective view of the kit 40 is shown. This illustration shows how kit 40 is configured with the lid 44 in a closed position. In this configuration kit 40 is ready for use to, for example, insert a tire plug into a tire puncture wound.

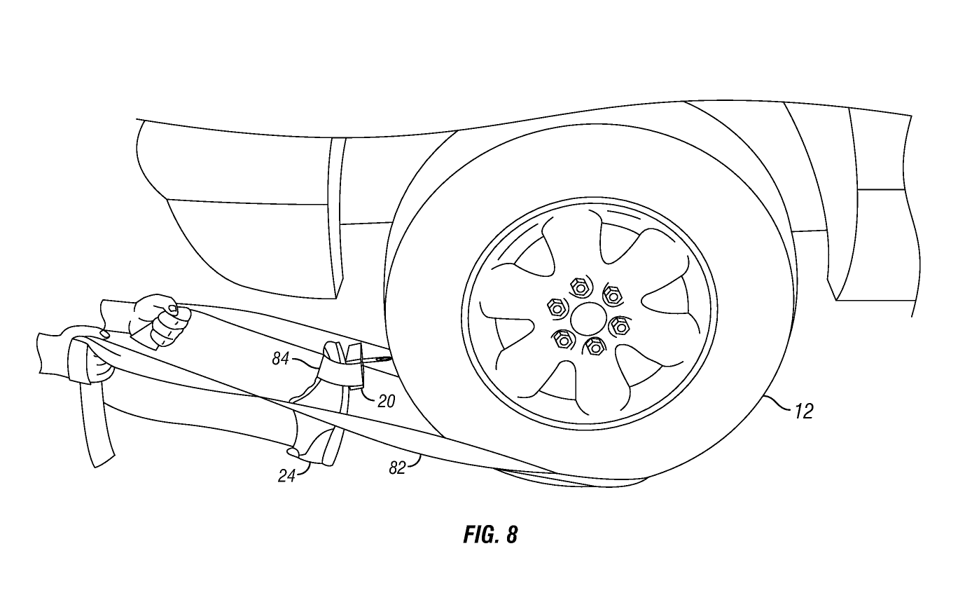

FIG. 7 shows a cross-sectional view of the kit 40 in the closed configuration. As illustrated, the lid 44 is securely attached to the container 42 by the hinge 46 and the latch 48. The insertion tool 50 is held firmly in place by the tool retention member 52.

In operation, a tire plug (not shown) is fitted to the insertion tool 50. The insertion tool 50 is secured in place in the tool retention member 52 after being passed through the orifice 54 in the lid 44. Once the lid 44 is securely attached to the latch 48, the kit 40 is positioned relative to a tire such that the insertion tool 50 is lined up axially with a puncture wound of the tire to be repaired. Then the tire insertion tool 50 is driven into the tire puncture wound by application of force by a human foot to the external bottom surface 56 of the container 42. Accordingly, container 42 must be suitably sized to allow for a human foot to apply comfortably significant force onto the surface 56.

Use of kit 40 to repair a tire puncture wound does not require that the tire be dismounted from the vehicle or that the tire be removed from the wheel on which it is mounted. That is, advantageously, the kit 40 allows repair of a tire puncture wound while the tire remains attached to the vehicle. Because the kit 40 allows force multiplication by allowing application of force via a human foot and/or leg, the physical effort and/or strength required to drive the tire insertion tool 50 into a tire puncture wound is significantly reduced when compared to known tools and methods.

It should be noted that kit 40 is configured to receive implements other than the insertion tool 50. For example, a reamer or an awl can be received and secured in the tool retention member 52. Additionally, the container 42 can be configured to house the insertion tool 50, reamer, awl, tire plugs, cement, knife, blade, or other items desired in repairing a tire puncture wound.

Referencing FIG. 8 now, in one embodiment, the kit 40 can include a leverage strap 82 that can be used to ensure that the operator can effectively apply a foot force to the tire plug insertion tool 20. The leverage strap 82 is preferably made a of suitable material that can withstand significant force without tearing. As illustrated in FIG. 8, in one embodiment, the leverage strap 82 is wrapped behind or underneath a vehicle tire 12 in such a way that the operator can pull on the ends of the leverage strap 82 and thereby have the support to be able to effectively apply the force from the foot 24 to the plug insertion tool 20. In yet another embodiment, the plug insertion tool 20 can be provided with a foot strap 84 to ensure that the foot 24 is conveniently secured to the tire plug insertion tool 20. Preferably the foot strap 24 is detachably coupled to the plug insertion tool 20, such as by way of velcro strips or snap fasteners, for example. In another embodiment, the foot strap 24 can be rigidly attached to the plug insertion tool 20. As FIG. 8 shows, in operation the operator inserts the foot 24 into the foot strap 24 in order to facilitate applying foot force to the tire plug insertion tool 20. The foot strap 24 can be made of a suitable material such as cloth, leather, corduroy, and the like. In some embodiments, the leverage strap 82 and the foot strap 24 are made of the same material. The container 42 can be configured to allow storage of one or both of the leverage strap 82 and the foot strap 24.

While the invention has been described with reference to exemplary embodiments, it will be understood by those skilled in the relevant technology that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A tire puncture wound repair kit comprising:
a container portion adapted to allow application of force to a surface of said container by a human foot;
a lid fastened to said container, wherein said lid includes an orifice configured to allow the passage of the shank of a tire repair implement; and
a tool retention member affixed to said container and configured to receive part of said shank.

2. The tire puncture wound repair kit of claim 1, wherein the container portion is configured to house at least one tire repair implement.

3. The tire puncture wound repair kit of claim 1, wherein the lid is releasably fastened to said container by a hinge and a latch.

4. The tire puncture wound repair kit of claim 1, further comprising a foot strap coupled to said container.

5. The tire puncture wound repair kit of claim 1, further comprising a leverage strap configured to facilitate the application of foot force to said container, wherein the leverage strap comprises two distal ends that can be grasped with the hands.

6. A method of repairing a tire puncture wound, the method comprising:
affixing a tire plug insertion tool to a container; and
applying force via a human foot to the container to drive the tire plug insertion tool into the tire puncture wound.

7. The method of claim 6, wherein affixing a tire plug insertion tool comprises providing a tool retention member coupled to said container.

8. The method of claim 6, wherein applying force via a human foot comprises providing a surface on said container, said surface suitably adapted to receive application of force by a human foot.

9. The method of claim 6, wherein applying force via a human foot further comprises providing a foot strap coupled to said container, and wherein the foot strap is adapted to receive and retain a human foot.

10. The method of claim 6, further comprising providing a leverage strap configured to be wrapped around a tire, and pulling the free ends of the leverage strap simultaneously with applying force via a human foot.

11. A tire puncture wound repair tool comprising:
a platform configured to receive application of force by a human foot;
a tire repair implement coupled to said platform; and
wherein said platform and said tire repair implement are configured such that application of force by a human foot to said platform drives said tire repair implement into the tire puncture wound.

12. The tire puncture wound repair tool of claim 11, wherein said platform comprises a container portion.

13. The tire puncture wound repair tool of claim 12, wherein said platform comprises a lid releasably attached to said container portion.

14. The tire puncture wound repair tool of claim 12, wherein said container portion comprises a retaining member for receiving and securing said tire repair implement.

15. The tire puncture wound repair tool of claim 11, further comprising a leverage strap configured to be wrapped around a tire and to be pulled by its free ends as said human foot applies force to said platform.

16. The tire puncture wound repair tool of claim 11, further comprising a foot strap coupled to the platform.
